(19) United States
(12) Patent Application Publication
(10) Pub. No.: US 2025/0113223 A1
(43) Pub. Date: Apr. 3, 2025

(54) MEASUREMENT GAP SHARING WITH DELAY CRITICAL TRAFFIC

(71) Applicant: QUALCOMM Incorporated, San Diego, CA (US)

(72) Inventors: Prashant SHARMA, San Marcos, CA (US); Linhai HE, San Diego, CA (US); Changhwan PARK, San Diego, CA (US)

(21) Appl. No.: 18/480,247

(22) Filed: Oct. 3, 2023

(51) Int. Cl. H04W 24/08

(52) U.S. Cl. CPC H04W 24/08

(57) ABSTRACT

Methods, systems, and devices for wireless communications are described. A network entity may transmit, to a user equipment (UE), a configuration including a parameter indicating a quantity of scheduled measurement gaps that may be used for performing measurements. The UE may apply the parameter by suppressing one or more measurement gaps and may receive data from the network entity via one or more time resources (e.g., a slot, a symbol) associated with the suppressed measurement gaps. The UE may perform measurements during the measurement gaps that are not dropped. In some examples, the network entity may configure the parameter based on scheduled data traffic, one or more criteria associated with the UE satisfying a threshold, or any combination thereof. In some examples, the UE may stop applying the parameter based on a timer, an event trigger, or both.

### TECHNICAL FIELD

The following relates to wireless communications, including measurement gap sharing with delay critical traffic.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Components within a wireless communication system may be coupled (for example, operatively, communicatively, functionally, electronically, and/or electrically) to each other.

### SUMMARY

The described techniques relate to improved methods, systems, devices, and apparatuses that support measurement gap sharing with delay critical traffic. For example, the described techniques provide for a network entity transmitting, to a user equipment (UE), a configuration including a parameter indicating a quantity of scheduled measurement gaps that may be used for performing measurements. The UE may perform the measurements on signals transmitted from a neighboring network entity as a part of a mobility event. In some examples, the quantity may be a fraction or a percentage of the scheduled measurement gaps. The UE may apply the parameter by suppressing one or more measurement gaps and may receive data (e.g., extended reality (XR) traffic) from the network entity using one or more time resources (e.g., a slot, a symbol) associated with the suppressed measurement gaps. The UE may continue to perform measurements during the measurement gaps that are not dropped. In some examples, the network entity may configure (e.g., statically, dynamically) the parameter based on scheduled XR traffic, one or more criteria associated with the UE (e.g., signal measurements, a mobility state of the UE) satisfying a threshold, or any combination thereof. Similarly, the UE may determine to activate or deactivate applying the parameter based on the scheduled XR traffic, the one or more criteria associated with the UE satisfying the threshold, or any combination thereof. In some examples, the UE may determine to deactivate (e.g., stop applying) the parameter based on a timer, an event trigger, or both.

A method for wireless communication by a user equipment (UE) is described. The method may include receiving an indication of a configuration for a set of multiple measurement occasions, the configuration including a periodicity of the set of multiple measurement occasions and a parameter indicating a metric for sharing the set of multiple measurement occasions between performing measurements and communication of data, performing measurements during a first subset of the set of multiple measurement occasions, and communicating one or more data messages during one or more time periods that overlap at least partially with a second subset of the set of multiple measurement occasions, where one or more measurements are suppressed during the second subset of the set of multiple measurement occasions, and where a first quantity of measurement occasions of the first subset of the set of multiple measurement occasions and a second quantity of measurement occasions of the second subset of the set of multiple measurement occasions are determined based on the parameter.

A UE for wireless communication is described. The UE may include one or more memories storing processor executable code, and one or more processors coupled with the one or more memories. The one or more processors may individually or collectively operable to execute the code (e.g., directly, indirectly, after pre-processing, without pre-processing) to cause the UE to receive an indication of a configuration for a set of multiple measurement occasions, the configuration including a periodicity of the set of multiple measurement occasions and a parameter indicating a metric for sharing the set of multiple measurement occasions between performing measurements and communication of data, perform measurements during a first subset of the set of multiple measurement occasions, and communicate one or more data messages during one or more time periods that overlap at least partially with a second subset of the set of multiple measurement occasions, where one or more measurements are suppressed during the second subset of the set of multiple measurement occasions, and where a first quantity of measurement occasions of the first subset of the set of multiple measurement occasions and a second quantity of measurement occasions of the second subset of the set of multiple measurement occasions are determined based on the parameter.

Another UE for wireless communication is described. The UE may include means for receiving an indication of a configuration for a set of multiple measurement occasions, the configuration including a periodicity of the set of multiple measurement occasions and a parameter indicating a metric for sharing the set of multiple measurement occasions between performing measurements and communication of data, means for performing measurements during a first subset of the set of multiple measurement occasions, and means for communicating one or more data messages during one or more time periods that overlap at least partially with a second subset of the set of multiple measurement occasions, where one or more measurements are suppressed during the second subset of the set of multiple measurement occasions, and where a first quantity of measurement occasions of the first subset of the set of multiple measurement occasions and a second quantity of measurement occasions of the second subset of the set of multiple measurement occasions are determined based on the parameter.

A non-transitory computer-readable medium storing code for wireless communication is described. The code may include instructions executable by a processor (e.g., directly, indirectly, after pre-processing, without pre-processing) to receive an indication of a configuration for a set of multiple measurement occasions, the configuration including a periodicity of the set of multiple measurement occasions and a parameter indicating a metric for sharing the set of multiple measurement occasions between performing measurements and communication of data, perform measurements during a first subset of the set of multiple measurement occasions, and communicate one or more data messages during one or more time periods that overlap at least partially with a second subset of the set of multiple measurement occasions, where one or more measurements are suppressed during the second subset of the set of multiple measurement occasions, and where a first quantity of measurement occasions of the first subset of the set of multiple measurement occasions and a second quantity of measurement occasions of the second subset of the set of multiple measurement occasions are determined based on the parameter.

In some examples of the method, user equipment (UEs), and non-transitory computer-readable medium described herein, the metric may be a percentage value of the set of multiple measurement occasions, a fraction of the set of multiple measurement occasions, or any combination thereof.

In some examples of the method, user equipment (UEs), and non-transitory computer-readable medium described herein, the parameter further includes a second metric for sharing the first subset of the set of multiple measurement occasions between intra-frequency measurements and inter-frequency measurements.

Some examples of the method, user equipment (UEs), and non-transitory computer-readable medium described herein may further include operations, features, means, or instructions for applying the configuration to the set of multiple measurement occasions based on a data type, one or more criteria associated with the UE satisfying a threshold, or any combination thereof.

In some examples of the method, user equipment (UEs), and non-transitory computer-readable medium described herein, the data type may be XR traffic, ultra-reliable and low latency communications (URLLC) traffic, or a combination thereof.

In some examples of the method, user equipment (UEs), and non-transitory computer-readable medium described herein, the one or more criteria include criteria of one or more signal measurements performed by the UE on a serving cell associated with a network entity, a radio resource management relaxation condition, a quantity of data buffered in a logical channel, or any combination thereof.

In some examples of the method, user equipment (UEs), and non-transitory computer-readable medium described herein, the one or more signal measurements performed by the UE on the serving cell associated with the network entity include a reference signal received power (RSRP), a reference signal received quality (RSRQ), or both.

Some examples of the method, user equipment (UEs), and non-transitory computer-readable medium described herein may further include operations, features, means, or instructions for applying the configuration to the set of multiple measurement occasions for a duration subsequent to a data communication based on a timer associated with communicating data with a network entity.

Some examples of the method, user equipment (UEs), and non-transitory computer-readable medium described herein may further include operations, features, means, or instructions for suspending application of the configuration to the set of multiple measurement occasions based on an event trigger.

In some examples of the method, user equipment (UEs), and non-transitory computer-readable medium described herein, the event trigger includes a radio link failure (RLF), a beam failure recovery, a candidate beam detection, a RSRP satisfying a first threshold, a RSRQ satisfying a second threshold, or any combination thereof.

Some examples of the method, user equipment (UEs), and non-transitory computer-readable medium described herein may further include operations, features, means, or instructions for determining a cell-detection period, a synchronization signal block (SSB) index identification period, a measurement period, or any combination thereof based on a scaling factor associated with the parameter.

Some examples of the method, user equipment (UEs), and non-transitory computer-readable medium described herein may further include operations, features, means, or instructions for transmitting an indication that the UE may be applying the parameter based on one or more criteria associated with the UE satisfying a threshold.

In some examples of the method, user equipment (UEs), and non-transitory computer-readable medium described herein, the indication may be received via downlink control information (DCI), a medium access control-control element (MAC-CE), radio resource control (RRC) signaling, a system information (SI) message, or any combination thereof.

Some examples of the method, user equipment (UEs), and non-transitory computer-readable medium described herein may further include operations, features, means, or instructions for performing intra-frequency measurements, inter-frequency measurements, or any combination thereof.

A method for wireless communication by a network entity is described. The method may include transmitting, to a UE, an indication of a configuration for a set of multiple measurement occasions, the configuration including a periodicity of the set of multiple measurement occasions and a parameter indicating a metric for sharing the set of multiple measurement occasions between performing measurements and communication of data and communicating one or more data messages with the UE during one or more time periods that overlap at least partially with a subset of the set of multiple measurement occasions.

A network entity for wireless communication is described. The network entity may include one or more memories storing processor executable code, and one or more processors coupled with the one or more memories. The one or more processors may individually or collectively operable to execute the code (e.g., directly, indirectly, after pre-processing, without pre-processing) to cause the network entity to transmit, to a UE, an indication of a configuration for a set of multiple measurement occasions, the configuration including a periodicity of the set of multiple measurement occasions and a parameter indicating a metric for sharing the set of multiple measurement occasions between performing measurements and communication of data and communicate one or more data messages with the UE during one or more time periods that overlap at least partially with a subset of the set of multiple measurement occasions.

Another network entity for wireless communication is described. The network entity may include means for transmitting, to a UE, an indication of a configuration for a set of multiple measurement occasions, the configuration including a periodicity of the set of multiple measurement occasions and a parameter indicating a metric for sharing the set of multiple measurement occasions between performing measurements and communication of data and means for communicating one or more data messages with the UE during one or more time periods that overlap at least partially with a subset of the set of multiple measurement occasions.

A non-transitory computer-readable medium storing code for wireless communication is described. The code may include instructions executable by a processor (e.g., directly, indirectly, after pre-processing, without pre-processing) to transmit, to a UE, an indication of a configuration for a set of multiple measurement occasions, the configuration including a periodicity of the set of multiple measurement occasions and a parameter indicating a metric for sharing the set of multiple measurement occasions between performing measurements and communication of data and communicate one or more data messages with the UE during one or more time periods that overlap at least partially with a subset of the set of multiple measurement occasions.

In some examples of the method, network entities, and non-transitory computer-readable medium described herein, the configuration may be based on a data type, one or more criteria associated with the UE satisfying a threshold, or any combination thereof.

In some examples of the method, network entities, and non-transitory computer-readable medium described herein, the data type may be XR traffic, URLLC traffic, or a combination thereof.

In some examples of the method, network entities, and non-transitory computer-readable medium described herein, the one or more criteria include criteria of one or more signal measurements performed by the UE on a serving cell associated with a network entity, a radio resource management relaxation condition, a quantity of data buffered in a logical channel, or any combination thereof.

In some examples of the method, network entities, and non-transitory computer-readable medium described herein, the one or more signal measurements performed by the UE on the serving cell associated with the network entity include a RSRP, a RSRQ, or both.

In some examples of the method, network entities, and non-transitory computer-readable medium described herein, the metric may be a percentage value of the set of multiple measurement occasions, a fraction of the set of multiple measurement occasions, or any combination thereof.

Some examples of the method, network entities, and non-transitory computer-readable medium described herein may further include operations, features, means, or instructions for performing intra-frequency measurements, inter-frequency measurements, or any combination thereof.

In some examples of the method, network entities, and non-transitory computer-readable medium described herein, the parameter further includes a second metric for sharing a second subset of the set of multiple measurement occasions between intra-frequency measurements and inter-frequency measurements.

Some examples of the method, network entities, and non-transitory computer-readable medium described herein may further include operations, features, means, or instructions for determine a cell-detection period, a SSB index identification period, a measurement period, or any combination thereof based on a scaling factor associated with the parameter.

Some examples of the method, network entities, and non-transitory computer-readable medium described herein may further include operations, features, means, or instructions for receiving an indication that the UE may be applying the parameter based on one or more criteria associated with the UE satisfying a threshold.

In some examples of the method, network entities, and non-transitory computer-readable medium described herein, the indication may be transmitted via DCI, a MAC-CE, RRC signaling, a SI message, or any combination thereof.

### BRIEF DESCRIPTION OF THE DRAWINGS

FIG. 1 shows an example of a wireless communications system that supports measurement gap sharing with delay critical traffic in accordance with one or more aspects of the present disclosure.

FIG. 2 shows an example of a wireless communications system that supports measurement gap sharing with delay critical traffic in accordance with one or more aspects of the present disclosure.

FIG. 3 shows an example of a communications timeline that supports measurement gap sharing with delay critical traffic in accordance with one or more aspects of the present disclosure.

FIG. 4 shows an example of a process flow that supports measurement gap sharing with delay critical traffic in accordance with one or more aspects of the present disclosure.

FIGS. 5 and 6 show block diagrams of devices that support measurement gap sharing with delay critical traffic in accordance with one or more aspects of the present disclosure.

FIG. 7 shows a block diagram of a communications manager that supports measurement gap sharing with delay critical traffic in accordance with one or more aspects of the present disclosure.

FIG. 8 shows a diagram of a system including a device that supports measurement gap sharing with delay critical traffic in accordance with one or more aspects of the present disclosure.

FIGS. 9 and 10 show block diagrams of devices that support measurement gap sharing with delay critical traffic in accordance with one or more aspects of the present disclosure.

FIG. 11 shows a block diagram of a communications manager that supports measurement gap sharing with delay critical traffic in accordance with one or more aspects of the present disclosure.

FIG. 12 shows a diagram of a system including a device that supports measurement gap sharing with delay critical traffic in accordance with one or more aspects of the present disclosure.

FIGS. 13 through 17 show flowcharts illustrating methods that support measurement gap sharing with delay critical traffic in accordance with one or more aspects of the present disclosure.

### DETAILED DESCRIPTION

In some wireless communications systems, a user equipment (UE) may communicate with a network entity associated with a respective serving cell. The UE may be configured to receive delay-sensitive traffic (e.g., extended reality (XR) traffic) from the network entity according to a discontinuous reception (DRX) cycle. In some examples, the UE may move within the serving cell and may trigger a mobility event. In such examples, as a part of the mobility event, the network entity may configure the UE with one or more measurement gaps (e.g., occasions in time) for performing measurements on signals transmitted from a neighboring network entity (e.g., associated with a neighboring cell). In some cases, the neighboring cell may operate using a frequency different from a frequency used by the serving cell. In such cases, the UE may tune away from the serving cell frequency and may tune to the neighboring cell frequency to perform measurements on the neighboring cell during the one or more measurement gaps. However, a measurement gap may overlap in time with the DRX cycle, and the UE may not be able to transmit or receive data with the network entity (e.g., associated with the serving cell) during the measurement gap. Additionally, or alternatively, a DRX active duration may expire during the measurement gap, and any data that was not successfully transmitted to the UE may be deferred to an upcoming DRX active duration, which may delay data transfer between the UE and the network entity.

Various aspects of the present disclosure are related to measurement gap sharing with delay critical traffic. In some examples, a network entity may configure a UE with a parameter associated with measurement gap sharing. The parameter may define a quantity of configured measurement gaps that may be used for performing measurements (e.g., inter-frequency, intra-frequency). In some examples, the parameter may be a fraction or a percentage of the configured measurement gaps. The UE may suppress one or more measurement gaps based on the parameter and may receive data (e.g., XR traffic) from the network entity according to a configured DRX cycle. In some examples, the parameter may be configured based on scheduled XR traffic, one or more criteria associated with the UE (e.g., signal measurements, a mobility state of the UE) satisfying a threshold, or any combination thereof. In some examples, the network entity may dynamically adjust the parameter based on a change in the scheduled XR traffic, a change in the one or more criteria associated with the UE, the presence of buffered data at the UE, or any combination thereof. Additionally, or alternatively, the UE or the network entity may determine one or more parameters associated with cell detection, synchronization signal block index identification, or measurement based on the value of a scaling factor associated with the parameter.

Aspects of the disclosure are initially described in the context of wireless communications systems. Aspects of the disclosure are additionally illustrated by and described with reference to communication timelines and process flows. Aspects of the disclosure are further illustrated by and described with reference to apparatus diagrams, system diagrams, and flowcharts that relate to measurement gap sharing with delay critical traffic.

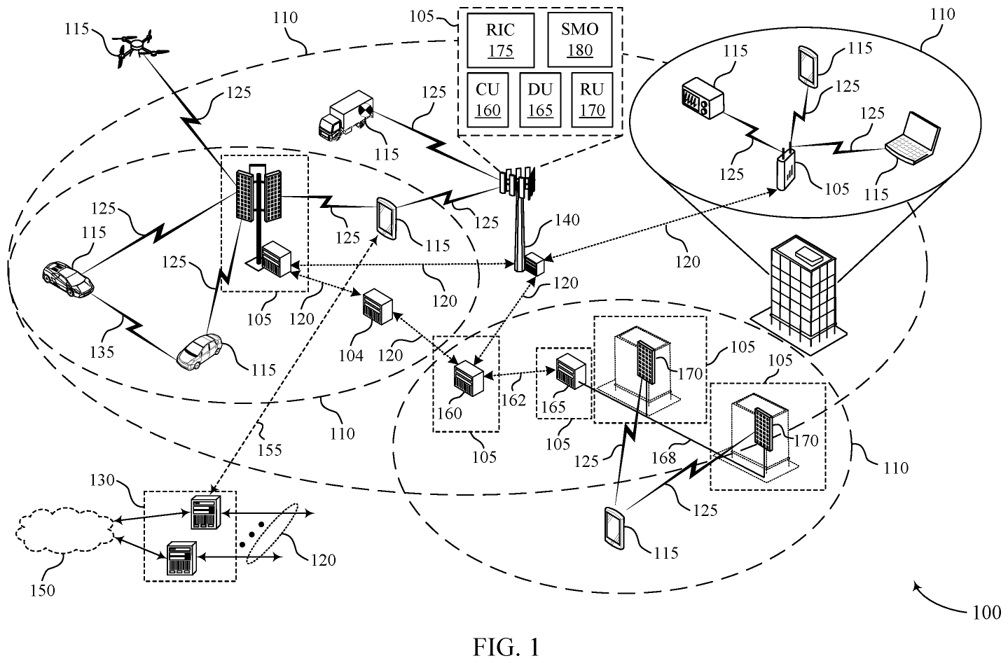

FIG. 1 shows an example of a wireless communications system 100 that supports measurement gap sharing with delay critical traffic in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support measurement gap sharing with delay critical traffic as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, a UE 115 may communicate data with a network entity 105 associated with a serving cell (e.g., a coverage area 110) according to a DRX cycle. The UE 115 may also perform one or more measurements (e.g., inter-frequency, intra-frequency) on signals transmitted by a neighboring (e.g., second) network entity during one or more measurement gaps. In some examples, the network entity 105 may configure the UE 115 with a parameter associated with measurement gap sharing. For example, the parameter may indicate a quantity of the scheduled measurement gaps that may be used for performing the measurements on signals transmitted from the neighboring network entity 105. In some examples, the parameter may be a fraction or a percentage of the scheduled measurement gaps. The UE 115 may apply the parameter by suppressing one or more measurement gaps and may receive data (e.g., XR traffic) from the network entity 105 using one or more time resources (e.g., a slot, a symbol) associated with the suppressed measurement gaps. The UE 115 may continue to perform measurements during the measurement gaps that are not dropped.

In some examples, the network entity 105 may configure the parameter based on scheduled XR traffic, one or more criteria associated with the UE 115 (e.g., signal measurements, a mobility state of the UE) satisfying a threshold, or any combination thereof. Similarly, the UE 115 may determine to activate or deactivate applying the parameter based on the scheduled XR traffic, the one or more criteria associated with the UE satisfying the threshold, or any combination thereof. In some examples, the UE 115 may determine to deactivate (e.g., stop applying) the parameter based on a timer, an event trigger, or both. In some examples, the network entity 105 may dynamically adjust the parameter based on a change in the scheduled XR traffic, the one or more criteria associated with the UE 115, the presence of buffered data at the UE 115, or any combination thereof. Additionally, or alternatively, the UE 115 or the network entity 105 may determine one or more parameters associated with cell detection, synchronization signal block index identification, or measurement based on the value of a scaling factor associated with the parameter.

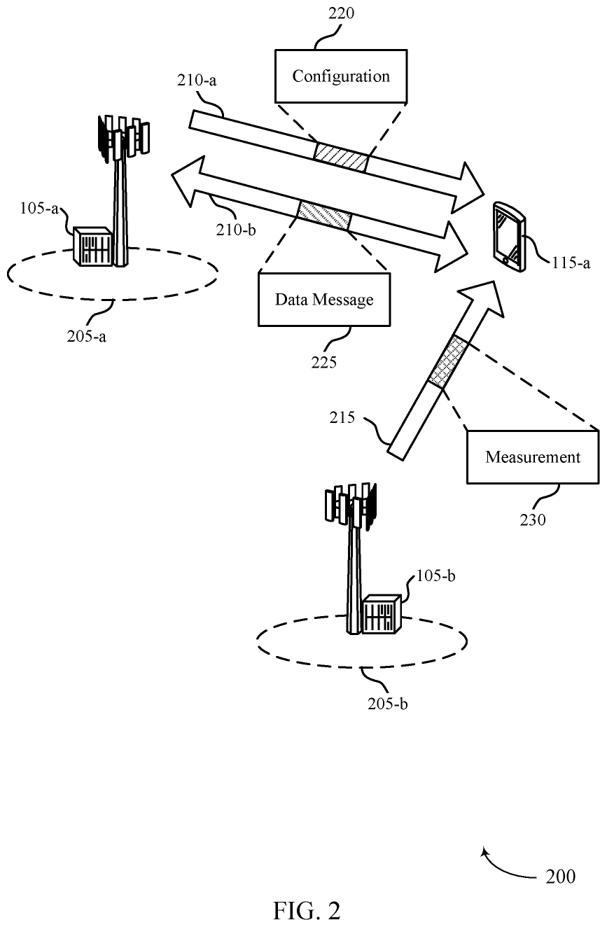

FIG. 2 shows an example of a wireless communications system 200 that supports measurement gap sharing with delay critical traffic in accordance with one or more aspects of the present disclosure. The wireless communications system 200 may include a UE 115-a, a network entity 105-a, and a neighboring network entity 105-b. The UE 115-a may communicate with the network entity 105-a, the neighboring network entity 105-b, or both. The network entity 105-a may be associated with a serving cell 205-a, and the neighboring network entity 105-b may be associated with a neighboring cell 205-b. The UE 115-a may communicate with the network entity 105-a via communication links 210-a and 210-b. Similarly, the UE 115-a may receive signaling 215 from the neighboring network entity via a communication link. The communication link 210-a and the communication link 210-b may be examples of cellular links (e.g., Uu links).

In some examples, the UE 115-a may be located within the serving cell 205-a and may communicate with the network entity 105-a according to a configuration 220 transmitted by the network entity 105-a. For example, the UE may operate according to a discontinuous reception (DRX) mode, and the network entity 105-a and the UE 115-a may communicate (e.g., periodically) one or more data messages 225 according to the configuration 220 and the DRX mode. In some cases, due to UE movement within the serving cell 205-a, the UE 115-a may trigger a mobility event (e.g., a Fifth Generation (5G) New Radio (NR) A3 event). In such cases the UE 115-a may perform measurements 230 (e.g., inter-frequency measurements, intra-frequency measurements) on the signaling 215 transmitted by the neighboring network entity 105-b. Based on triggering the mobility event, the network entity 105-a may configure the UE 115-a to perform the measurements 230 on candidate neighboring cells including the neighboring cell 205-b.

In some examples, the neighboring cell s05-b may use a same frequency as the frequency used by the serving cell 205-a. In some other examples, the neighboring cell 205-b may use a frequency different from the frequency used by the serving cell 205-a. In such examples, the UE may tune away from the frequency used by the serving cell 205-a and may tune into the frequency used by the neighboring cell 205-b. The UE 115-a may be configured with one or more measurement gaps (e.g., time occasions) for performing the measurements 230 on the signaling 215 transmitted by the neighboring cell 205-b. The UE 115-a may not transmit or receive signaling (e.g., data) with the network entity 105-a during a measurement gap. Accordingly, measurement gaps may delay data transfer between the UE 115-a and the network entity 105-a.

In some examples, the network entity 105-a may transmit a configuration 220 to the UE 115-a. In such examples, the network entity 105-a may configure the UE 115-a with a sharing parameter that defines a quantity of scheduled measurement gaps for performing measurements. For example, the sharing parameter may indicate a fraction of scheduled measurement gaps that may be used for performing the measurements 230 on the neighboring cell 205-b. The quantity of scheduled measurement gaps may be a fraction value or a percentage value of the scheduled measurement gaps. In some examples, the network entity 105-a may indicate the quantity of scheduled measurement gaps using one or more bits. For example, the network entity 105-a may use a two-bit signaling scheme to indicate a percentage value corresponding to a quantity of scheduled measurement gaps to be prioritized over communicating data with the network entity 105-a. Table 1 illustrates an example bit configuration that corresponds to a percentage of measurement gaps.

TABLE 1

| measGapDataSharingScheme | X (%) |
|---|---|
| “00” | 100 |
| “01” | 75 |
| “10” | 50 |
| “11” | 25 |

In the example of Table 1, a measGapDataSharingScheme bit value of “00” may indicate that all of the scheduled measurement gaps should be used for performing the measurements 230 (e.g., according to legacy procedures). A bit value of “01” may indicate that at least (or approximately) 75% of the scheduled measurement gaps should be used for performing the measurements 230, a bit value of “10” may indicate that at least (or approximately) 50% of the scheduled measurement gaps should be used for performing the measurements 230, and a bit value of “11” may indicate that at least (or approximately) 25% of the scheduled measurement gaps should be used for performing the measurements 230. The remainder of the scheduled measurement gaps that are not indicated to be used for performing the measurements 230 are suppressed (e.g., dropped, cancelled). In some examples, the slots and symbols corresponding to the suppressed measurement gaps may be used to transmit and receive the one or more data messages 225, which may contain delay-critical data (e.g., extended reality (XR) data, URLLC data).

The network entity 105-a may configure the UE with the sharing parameter based on one or more factors, including a scheduled data type, one or more UE-associated criteria satisfying a configured threshold, a quantity of buffered data, a capability of the UE to support the sharing parameter, or any combination thereof. For example, the network entity 105-a may configure the sharing parameter based on whether delay-critical traffic (e.g., XR traffic, URLLC traffic) is scheduled between the UE 115-a and the network entity 105-a. Additionally, or alternatively, the network entity 105-a may configure the sharing parameter based on one or more UE-associated criteria satisfying a configured threshold. The UE 115-a may similarly activate application of the configuration 220 (e.g., may apply the sharing parameter) based on the one or more factors. The network entity 105-a may indicate the configuration 220 to the UE dynamically, semi-statically, or statically. For example, the network entity 105-a may indicate the configuration to the UE 115-a via downlink control information (DCI), a medium access control-control element (MAC-CE), radio resource control (RRC) signaling, one or more system information (SI) messages, or any combination thereof.

In some examples, the UE-associated criteria may include one or more reported or measured UE signal measurements (e.g., a reference signal received power (RSRP), a reference signal received quality (RSRQ)) performed on the serving cell 205-a, and the network entity 105-a may configure the sharing parameter (or the UE 115-a may activate application of the configuration 220) based on the UE-associated criteria meeting a configured threshold. In such examples, the configured threshold may be below a threshold associated with triggering the initial mobility event (e.g., which triggers an initial configuration or enablement of the measurement gaps). In some other examples, the UE 115-a may satisfy one or more radio resource management relaxation conditions (e.g., the UE 115-a is stationary, the UE 115-a is low-mobility, the UE 115-a is not at the edge of the serving cell 205-a, or any combination thereof) and may report the result to the network entity 105-a. In such examples, a value of the sharing parameter may be larger if the UE 115-a satisfies more than one radio resource management relaxation conditions. Similarly, the sharing parameter may indicate to stop suppressing measurement gaps if the UE reports that at least one of the radio resource management relaxation conditions are not satisfied. In yet some other examples, the UE 115-a may suppress measurement gaps when a quantity of buffered data in one or more predetermined logical channels (e.g., a high-priority logical channel) satisfies a threshold. For example, the UE 115-a may apply the configuration 220 and suppress measurement gaps when a quantity of buffered data in a high-priority logical channel exceeds a threshold value. Similarly, the UE 115-a may stop applying the configuration 220 and may refrain from suppressing measurement gaps when the quantity of buffered data in the high-priority logical channel is below a threshold value.

In some examples, the network entity 105-a may dynamically adjust (e.g., reconfigure) the sharing parameter included in the configuration 220 based on a change in any of the one or more factors. For example, the network entity 105-a may adjust the sharing factor based on a change in the quantity of buffered data, a change in a mobility state at the UE 115-a, or any combination thereof. The network entity 105-a may indicate whether to activate or deactivate applying the sharing parameter to the UE 115-a via DCI, medium access control (MAC) signaling, or both.

The UE 115-a may apply the sharing parameter for a duration (e.g., an application time) according to a timer. In some examples, the UE 115-a may define a timer associated with communicating data with the network entity 105-a scheduled by a specific DCI format. In some examples, the UE 115-a may deactivate applying the sharing parameter when the timer expires. In such examples, the UE 115-a may reapply the sharing parameter according to a new timer based on receiving an indication from the network entity 105-a, one or more UE-associated criteria satisfying a threshold, or any combination thereof. For example, the UE 115-a may reapply the sharing parameter according to a new timer of the same duration or a new timer of a new duration based on failing to receive data from the network entity 105-a during the timer, failing to receive a threshold quantity of transmissions from the network entity 105-a during a DRX cycle, or both. Additionally, or alternatively, the UE may deactivate (e.g., release) applying the sharing parameter based on an event trigger. In some examples, the event trigger may include a radio link failure (RLF) event, a beam failure detection (BFD) event, a candidate beam detection (CBD) event, a RSRP satisfying a threshold, a RSRQ satisfying a threshold, or any combination thereof.

After receiving the configuration 220, the UE 115-a, the network entity 105-a, or both may drop a quantity of the scheduled measurement gaps corresponding to the sharing parameter indicated in the configuration 220. Accordingly, the UE 115-a and the network entity 105-a may communicate the one or more data messages 225 using the time resources (e.g., slots, symbols) associated with the dropped measurement gaps. The UE 115-a may still perform the measurements 230 on the signaling 215 transmitted by the neighboring network entity 105-b using the scheduled measurement gaps. Based on dropping one or more occasions associated with one or more respective measurement gaps, the UE 115-a and the network entity 105-a may experience delays in synchronization signal (e.g., primary synchronization signal (PSS), secondary synchronization signal (SSS)) detection, synchronization signal block (SSB) index identification, measurement, or any combination thereof. In some examples, the delays may be quantified by defining a scaling factor K_{MG-XR}·K_{MG-XR} may be equal to the inverse of X multiplied by 100, where X represents the quantity (e.g., percentage) of scheduled measurement gaps indicated by the sharing parameter. In such examples, the scaling factor may be represented by Equation 1.

$${K}_{M G - X R} = \frac{1}{X} * 100 \qquad ( 1 )$$

In some examples where the UE 115-a does not receive the configuration 220 or does not receive the sharing parameter included in the configuration 220, the value of the scaling factor may be equal to 1. In some other examples, the sharing parameter may indicate that all measurement gaps should be used for performing the measurements 230 (e.g., no measurement gaps should be cancelled). In such other examples, the value of the scaling factor may be equal to 1.

In some examples where delay-critical traffic is scheduled between the network entity 105-a and the UE 115-a, a quantity of SSB samples needed for performing cell searching, measurements, or both using measurement gaps may be scaled by the scaling factor. In such examples, the network entity 105-a may dynamically reconfigure the sharing parameter during a cell-detection period, a SSB index identification period, a measurement period, or any combination thereof. Accordingly, the network entity 105-a may change the scaling factor being used during the cell-detection period, SSB index identification period, measurement period, or any combination thereof, which may lead to uncertainty at the UE 115-a regarding requirements (e.g., parameters) of the UE 115-a for performing the corresponding cell-detection, SSB index identification, measurement, or any combination thereof. Accordingly, the network entity 105-a, the UE 115-a, or both, may determine an updated value for the one or more requirements of the UE 115-a to account for the changed scaling factor.

In some examples, the updated value may be determined based on a minimum cell-detection period, SSB index identification period, measurement period, or any combination thereof corresponding to the scaling factor before and after the network entity 105-a reconfigures the sharing parameter. In some other examples, the updated value may be determined based on a maximum cell-detection period, SSB index identification period, measurement period, or any combination thereof corresponding to the scaling factor before and after the network entity 105-a reconfigures the sharing parameter. In yet some other examples, the updated value may be determined based on a linear combination of the delays corresponding to the scaling factor before and after the network entity 105-a reconfigures the sharing parameter, where each delay is scaled by the quantity of samples measured before and after the network entity 105-a reconfigures the sharing parameter.

In some examples, the UE 115-a may be configured with an additional parameter (e.g., by the network entity 105-a) that indicates a quantity (e.g., a percentage value, a fraction value) of the scheduled measurement gaps that should be used for performing intra-frequency measurements. For example, the additional parameter may indicate that the scheduled measurement gaps should be split equally between performing intra-frequency measurements and performing inter-frequency measurements. In such examples, the UE 115-a may apply the additional parameter after applying the sharing parameter. For example, the UE 115-a may determine, based on the configuration 220, that at least (or approximately) 50% of the scheduled measurement gaps may be used for performing the measurements 230. The UE 115-a may further determine, based on the additional parameter, that the remaining measurement gaps should be split equally between performing intra-frequency measurements and performing inter-frequency measurements.

In some other examples, the UE 115-a may not be configured with the additional parameter. In such other examples, the sharing parameter indicated in the configuration 220 may further indicate sharing (e.g., splitting) measurement gaps between performing intra-frequency measurements and performing inter-frequency measurements. For example, the network entity 105-a may use a four-bit signaling scheme to indicate the sharing parameter, where the two most significant bits of the sharing parameter may indicate the quantity of scheduled measurement gaps for performing the measurements 230, and the two least significant bits of the sharing parameter may indicate the sharing of the remaining measurement gaps between performing intra-frequency measurements and performing inter-frequency measurements.

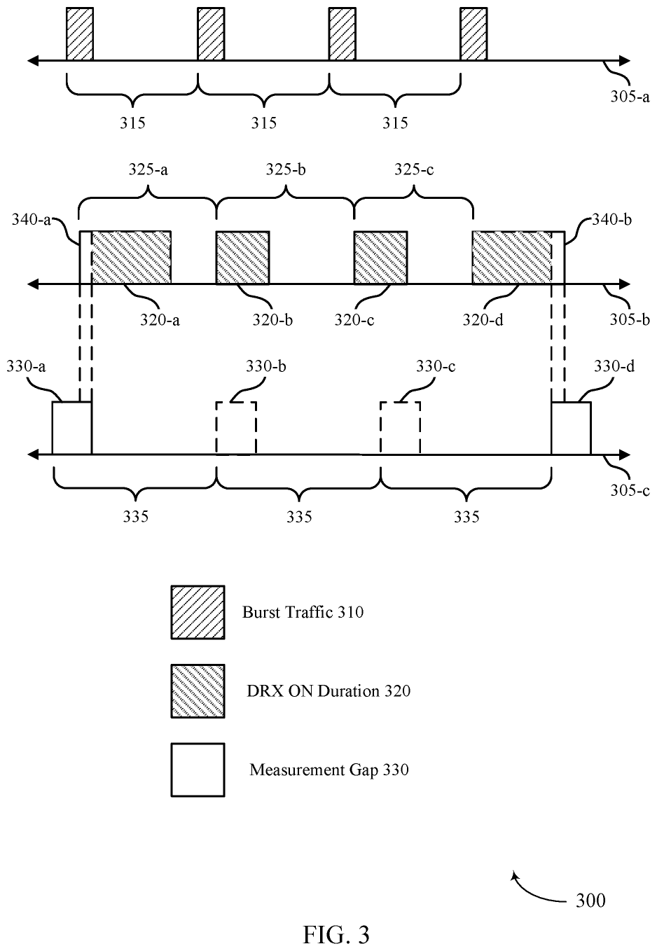

FIG. 3 shows an example of a communications timeline 300 that supports measurement gap sharing with delay critical traffic in accordance with one or more aspects of the present disclosure. The communications timeline 300 may illustrate an example for implementing one or more aspects of the wireless communications system 100. For example, the communications timeline 300 may depict or represent a flow of communications (e.g., signals, messages) between a UE and a network entity, which may be examples of corresponding devices as described herein, including with respect to FIG. 1. In some examples, the horizontal axis 305-a of the communications timeline 300 may represent a time component of communications between the UE and the network entity, and the horizontal axis 305-c may represent a time component of measurements performed by the UE. In some examples, the UE may operate according to a DRX configuration (e.g., a DRX mode), and the horizontal axis 305-b may represent a time component of a DRX cycle associated with the UE.

In some examples, the UE may communicate data with the network entity in the form of burst traffic 310. The burst traffic 310 may be associated with a periodicity 315 (e.g., a non-integer-based duration of 16.67 ms). The UE may receive data from the network entity according to a DRX mode. For example, the UE may receive data from the network entity according to a DRX cycle which may include multiple DRX ON durations 320 (e.g., including a first DRX ON duration 320-a, a second DRX ON duration 320-b, a third DRX ON duration 320-c, and a fourth DRX ON duration 320-d). The UE may receive the burst traffic 310 during a corresponding DRX ON duration 320 in time. The DRX ON durations 320 may be separated in time (e.g., may be periodic, semi-periodic, aperiodic). In some examples, the time durations 325 between the DRX ON durations 320 may not be uniform. For example, a value of the time duration 325-a may be the same as a value of the time duration 325-b (e.g., a duration of 17 ms), but may not be the same as a value of the time duration 325-c (e.g., a duration of 16 ms). The time durations 325 may not be the same as the periodicity 315.

The UE may also be configured with one or more measurement gaps 330, including a first measurement gap 330-a, a second measurement gap 330-b, a third measurement gap 330-c, a fourth measurement gap 330-d. The UE may be configured to perform measurements during the one or more measurement gaps 330. In some examples, the UE may perform the measurements on signals transmitted from a neighboring network entity (e.g., different from the network entity the UE is communicating data with) as a part of a mobility event. The measurement gaps 330 may be associated with an integer-based periodicity 335 (e.g., a duration of 20 ms). In some examples, a measurement gap 330 may overlap (e.g., partially, fully) in time with a DRX ON duration 320.

In some cases, the UE may not receive the burst traffic 310 during some or all of the corresponding DRX ON duration 320. For example, the UE may be performing measurements during a portion 340-a of the first DRX ON duration 320-a that corresponds to an overlap in time between the first DRX ON duration 320-a and the first measurement gap 330-a, and the UE may be unable to receive the burst traffic 310 without interrupting the measurements. In such cases, the UE may not receive burst traffic 310 during the portion 340-a of the first DRX ON duration 320-a. In some examples, the UE may determine to continue performing the measurements during the portion 340-a based on receiving a configuration from the network entity, which may be an example of a configuration 220 as described with respect to FIG. 2. Similarly, the UE may determine to stop receiving burst traffic 310 during a portion 340-b of the fourth DRX ON duration 320-d that corresponds to an overlap in time between the fourth DRX ON duration 320-d and the fourth measurement gap 330-d. In some cases where a DRX ON duration 320 ends (e.g., a DRX timer expires) during a measurement gap 330, the UE may deactivate and defer transmitting any remaining data packets of the burst traffic 310 until a following DRX ON duration 320 begins.

The configuration may indicate, to the UE, a quantity of measurement gaps 330 to be used for performing the measurements. For example, the configuration may indicate (e.g., explicitly) that at least (or approximately) 50% of the measurement gaps 330 should be used for performing the measurements and may indicate (e.g., implicitly) that the other (e.g., remaining) measurement gaps 330 can be suppressed (e.g., dropped, cancelled. In some examples where the UE is configured with four measurement gaps 330, the UE may determine to perform measurements during two measurement gaps 330 (e.g., the first measurement gap 330-a and the fourth measurement gap 330-d) and may determine to drop the remaining two measurement gaps 330 (e.g., the second measurement gap 330-b and the third measurement gap 330-c).

In some other cases, the UE may receive the burst traffic 310 during all of the corresponding DRX ON duration 320. For example, the UE may apply the configuration and suppress the second measurement gap 330-b and the third measurement gap 330-c. In such other cases, the UE may not be occupied with performing the measurements and can accordingly receive burst traffic 310 during the DRX ON durations 320 that overlap in time with the dropped measurement gaps 330 (e.g., the second measurement gap 330-b and the third measurement gap 330-c).

In some examples, the network entity may determine to activate application of the configuration based on one or more factors (e.g., a scheduled data type, one or more UE-associated criteria satisfying a threshold, a quantity of buffered data, or any combination thereof as described with respect to FIG. 2) and may indicate, to the UE, whether to activate or deactivate application of the configuration accordingly. Additionally, or alternatively, the network entity may dynamically adjust the configuration and may indicate, to the UE, whether to activate or deactivate application of an updated configuration. In some other examples, the UE may determine to activate application of the configuration based on the one or more factors. Additionally, or alternatively, the UE may be configured with a timer associated with applying the configuration, an event trigger, or both (which may be examples of corresponding features described herein, including with reference to FIG. 2), and the UE may determine to activate or deactivate applying the configuration based on expiration of the timer, the event trigger satisfying a threshold, or both.

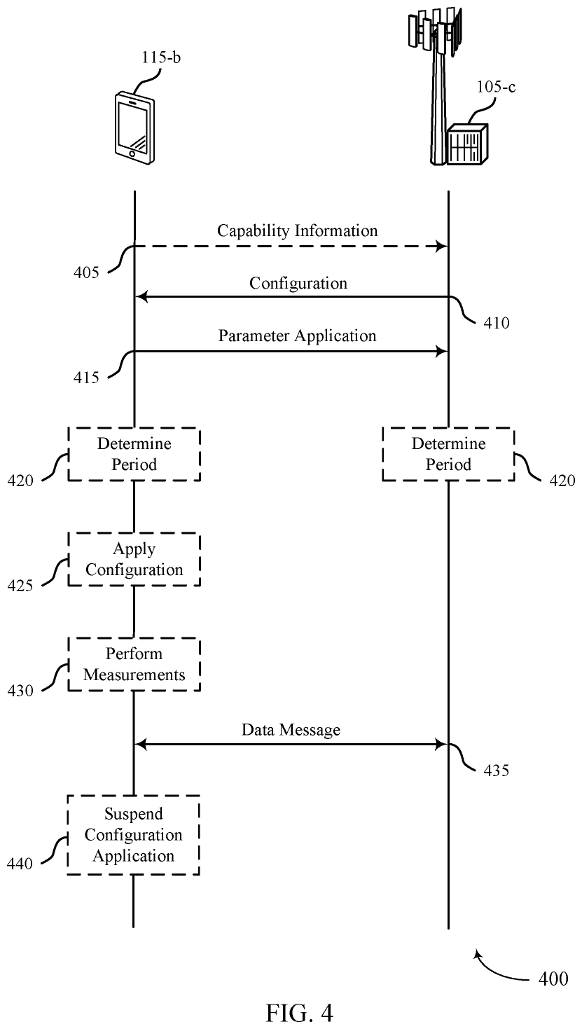

FIG. 4 shows an example of a process flow 400 that supports measurement gap sharing with delay critical traffic in accordance with one or more aspects of the present disclosure. The process flow 400 may implement or be implemented by aspects of the wireless communications system 100, the wireless communications system 200, and the communications timeline 300 as described with reference to FIGS. 1, 2, and 3. For instance, in the example of FIG. 4, a UE 115-b may be in communication with network entity 105-c, which may be examples of devices described herein with reference to FIG. 1 or FIG. 2. In the following description of the process flow 400, the operations between the UE 115-b and the network entity 105-c may be performed in a different order than the example shown, or the operations between the UE 115-b and the network entity 105-c may be performed in different orders at different times. Some operations may also be omitted form the process flow 400, and other operations may be added to the process flow 400.

At 405, the UE 115-b may transmit capability information to the network entity 105-c. The capability information may indicate a capability of the UE 115-b to support applying a parameter indicating a metric for sharing a plurality of configured measurement occasions between performing measurements and communicating data.

At 410, the UE 115-b may receive an indication of a configuration for a plurality of measurement occasions from the network entity 105-c. The configuration may include a periodicity of the plurality of measurement occasions and the parameter indicating a metric for sharing the plurality of measurement occasions between performing measurements and communication of data. The network entity 105-c may configure the UE 115-b with the parameter based on receiving the capability information from the UE 115-b. In some examples, the metric may be a percentage value of the plurality of measurement occasions, a fraction of the plurality of measurement occasions, or any combination thereof. The parameter may include a second metric for sharing the first subset of the plurality of measurement occasions between intra-frequency measurements and inter-frequency measurements. In some examples, the UE 115-b may receive the indication via DCI, a MAC-CE, RRC signaling, a SI message, or any combination thereof.

At 415, the UE 115-b may transmit, to the network entity 105-c, an indication that the UE 115-b is applying the parameter based on one or more criteria associated with the UE satisfying a threshold. In some examples, the parameter may indicate a scaling factor associated with one or more delays, including a delay in synchronization signal (e.g., PSS, SSS) detection, SSB index identification, measurements, or any combination thereof.

At 420, the UE 115-b, the network entity 105-c, or both the UE 115-b and the network entity 105-c may determine a cell-detection period, a SSB index identification period, a measurement period, or any combination thereof based on the scaling factor associated with the parameter.

At 425, the UE 115-b may apply the configuration to the plurality of measurement occasions based at least in part on a data type, one or more criteria associated with the UE 115-b satisfying a threshold, or any combination thereof. In some examples, the data type may include XR traffic, URLLC traffic, or any combination thereof. The one or more criteria may include one or more signal measurements performed by the UE 115-b on a serving cell associated with the network entity 105-c, a radio resource management relaxation condition, a quantity of data buffered in a logical channel, or any combination thereof. The one or more signal measurements performed by the UE 115-b on the serving cell associated with the network entity 105-c may include a RSRP, a RSRQ, or both. Additionally, or alternatively, the UE 115-b may apply the configuration to the plurality of measurement occasions for a duration subsequent to a data communication based on a timer associated with communicating data with the network entity 105-c.

At 430, the UE 115-b may perform measurements during a first subset of the plurality of measurement occasions. In some examples, the UE 115-b may perform intra-frequency measurements, inter-frequency measurements, or any combination thereof. The UE 115-b may perform the measurements in accordance with the configuration. For example, the UE 115-b may determine the first subset of the plurality of measurement occasions and a second subset of the plurality of measurement occasions based on the parameter included in the configuration.

At 435, the UE 115-b may communicate one or more data messages during one or more time periods that overlap at least partially with the second subset of the plurality of measurement occasions. In some examples, at least one measurement is suppressed during the second subset of the plurality of measurement occasions, and the UE 115-b may communicate the one or more data messages using a slot, a symbol, or both a slot and a symbol associated with the at least one suppressed measurement. The UE 115-b may determine a first quantity of measurement occasions of the first subset of the plurality of measurement occasions and a second quantity of measurement occasions of the second subset of the plurality of measurement occasions based on the parameter included in the configuration.

At 440, the UE 115-b may suspend application of the configuration to the plurality of measurement occasions based on an event trigger. In some examples, the event trigger may include a RLF event, a BFR procedure, a CBD procedure, a RSRP satisfying a first threshold, a RSRQ satisfying a second threshold, or any combination thereof. In some other examples, the UE 115-b may suspend application of the configuration to the plurality of measurement occasions based on an expiry of the timer.

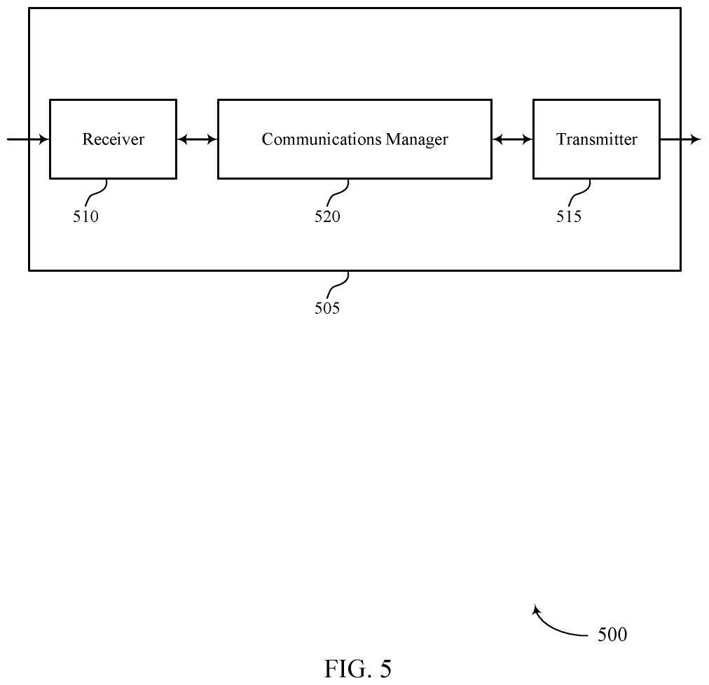

FIG. 5 shows a block diagram 500 of a device 505 that supports measurement gap sharing with delay critical traffic in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to measurement gap sharing with delay critical traffic). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to measurement gap sharing with delay critical traffic). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of measurement gap sharing with delay critical traffic as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software) executed by at least one processor. If implemented in code executed by at least one processor, the functions of the communications manager 520, the receiver 510, the transmitter 515, or various combinations or components thereof may be performed by a general-purpose processor, a DSP, a CPU, a GPU, a NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for receiving an indication of a configuration for a set of multiple measurement occasions, the configuration including a periodicity of the set of multiple measurement occasions and a parameter indicating a metric for sharing the set of multiple measurement occasions between performing measurements and communication of data. The communications manager 520 is capable of, configured to, or operable to support a means for performing measurements during a first subset of the set of multiple measurement occasions. The communications manager 520 is capable of, configured to, or operable to support a means for communicating one or more data messages during one or more time periods that overlap at least partially with a second subset of the set of multiple measurement occasions, where one or more measurements are suppressed during the second subset of the set of multiple measurement occasions, and where a first quantity of measurement occasions of the first subset of the set of multiple measurement occasions and a second quantity of measurement occasions of the second subset of the set of multiple measurement occasions are determined based on the parameter.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and the improved utilization of communication resources.

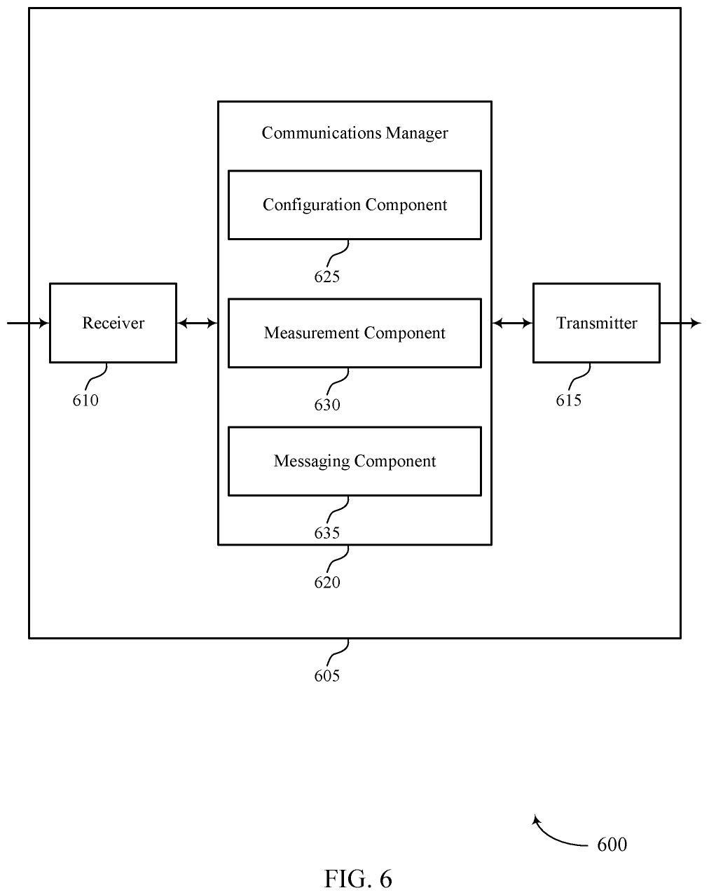

FIG. 6 shows a block diagram 600 of a device 605 that supports measurement gap sharing with delay critical traffic in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to measurement gap sharing with delay critical traffic). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to measurement gap sharing with delay critical traffic). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of measurement gap sharing with delay critical traffic as described herein. For example, the communications manager 620 may include a configuration component 625, a measurement component 630, a messaging component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The configuration component 625 is capable of, configured to, or operable to support a means for receiving an indication of a configuration for a set of multiple measurement occasions, the configuration including a periodicity of the set of multiple measurement occasions and a parameter indicating a metric for sharing the set of multiple measurement occasions between performing measurements and communication of data. The measurement component 630 is capable of, configured to, or operable to support a means for performing measurements during a first subset of the set of multiple measurement occasions. The messaging component 635 is capable of, configured to, or operable to support a means for communicating one or more data messages during one or more time periods that overlap at least partially with a second subset of the set of multiple measurement occasions, where one or more measurements are suppressed during the second subset of the set of multiple measurement occasions, and where a first quantity of measurement occasions of the first subset of the set of multiple measurement occasions and a second quantity of measurement occasions of the second subset of the set of multiple measurement occasions are determined based on the parameter.

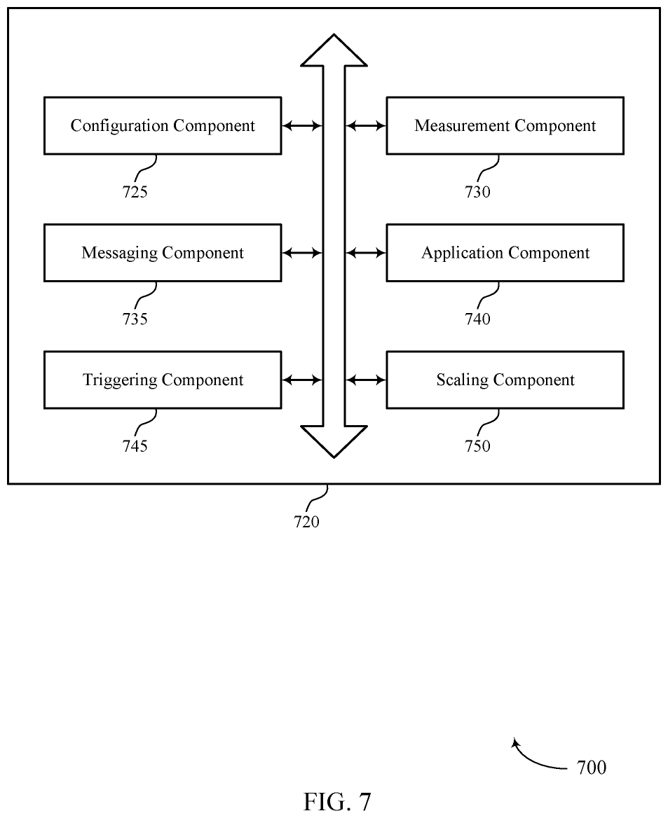

FIG. 7 shows a block diagram 700 of a communications manager 720 that supports measurement gap sharing with delay critical traffic in accordance with one or more aspects of the present disclosure. The communications manager 720 may be an example of aspects of a communications manager 520, a communications manager 620, or both, as described herein. The communications manager 720, or various components thereof, may be an example of means for performing various aspects of measurement gap sharing with delay critical traffic as described herein. For example, the communications manager 720 may include a configuration component 725, a measurement component 730, a messaging component 735, an application component 740, a triggering component 745, a scaling component 750, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The configuration component 725 is capable of, configured to, or operable to support a means for receiving an indication of a configuration for a set of multiple measurement occasions, the configuration including a periodicity of the set of multiple measurement occasions and a parameter indicating a metric for sharing the set of multiple measurement occasions between performing measurements and communication of data. The measurement component 730 is capable of, configured to, or operable to support a means for performing measurements during a first subset of the set of multiple measurement occasions. The messaging component 735 is capable of, configured to, or operable to support a means for communicating one or more data messages during one or more time periods that overlap at least partially with a second subset of the set of multiple measurement occasions, where one or more measurements are suppressed during the second subset of the set of multiple measurement occasions, and where a first quantity of measurement occasions of the first subset of the set of multiple measurement occasions and a second quantity of measurement occasions of the second subset of the set of multiple measurement occasions are determined based on the parameter.

In some examples, the metric is a percentage value of the set of multiple measurement occasions, a fraction of the set of multiple measurement occasions, or any combination thereof.

In some examples, the parameter further includes a second metric for sharing the first subset of the set of multiple measurement occasions between intra-frequency measurements and inter-frequency measurements.

In some examples, the application component 740 is capable of, configured to, or operable to support a means for applying the configuration to the set of multiple measurement occasions based on a data type, one or more criteria associated with the UE satisfying a threshold, or any combination thereof.

In some examples, the data type is extended reality (XR) traffic, ultra-reliable and low latency communications (URLLC) traffic, or a combination thereof.

In some examples, the one or more criteria include criteria of one or more signal measurements performed by the UE on a serving cell associated with a network entity, a radio resource management relaxation condition, a quantity of data buffered in a logical channel, or any combination thereof.

In some examples, the one or more signal measurements performed by the UE on the serving cell associated with the network entity include a reference signal received power, a reference signal received quality, or both.

In some examples, the application component 740 is capable of, configured to, or operable to support a means for applying the configuration to the set of multiple measurement occasions for a duration subsequent to a data communication based on a timer associated with communicating data with a network entity.

In some examples, the triggering component 745 is capable of, configured to, or operable to support a means for suspending application of the configuration to the set of multiple measurement occasions based on an event trigger.

In some examples, the event trigger includes a radio link failure, a beam failure recovery, a candidate beam detection, a reference signal received power satisfying a first threshold, a reference signal received quality satisfying a second threshold, or any combination thereof.

In some examples, the scaling component 750 is capable of, configured to, or operable to support a means for determining a cell-detection period, a synchronization signal block index identification period, a measurement period, or any combination thereof based on a scaling factor associated with the parameter.

In some examples, the indication is received via downlink control information, a medium access control-control element, radio resource control signaling, a system information message, or any combination thereof.

In some examples, the measurement component 730 is capable of, configured to, or operable to support a means for performing intra-frequency measurements, inter-frequency measurements, or any combination thereof.

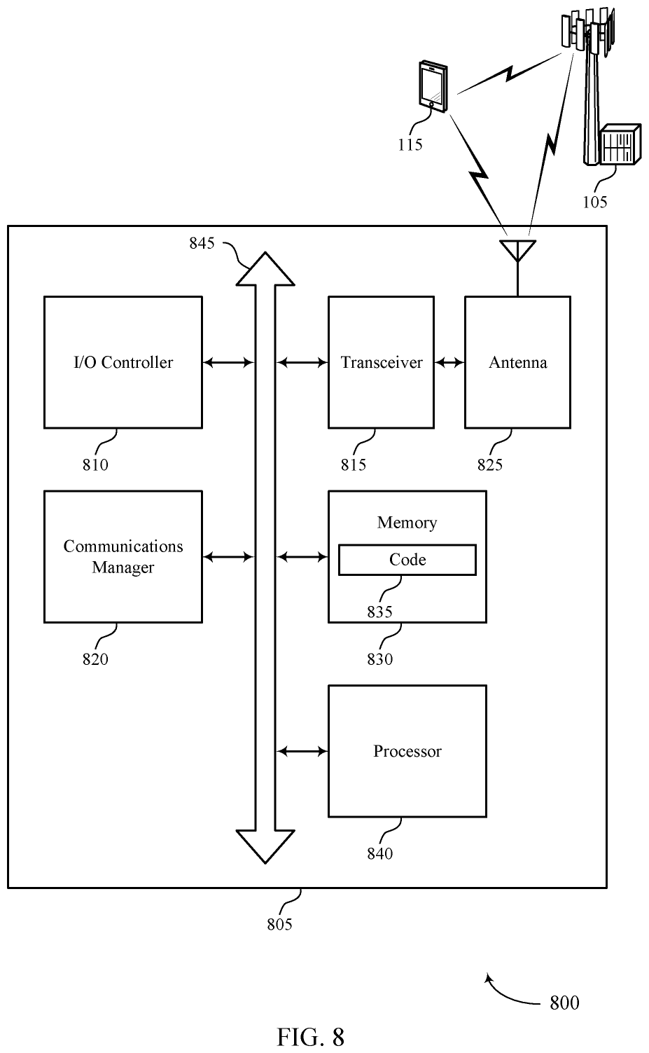

FIG. 8 shows a diagram of a system 800 including a device 805 that supports measurement gap sharing with delay critical traffic in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a GPU, a NPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting measurement gap sharing with delay critical traffic). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for receiving an indication of a configuration for a set of multiple measurement occasions, the configuration including a periodicity of the set of multiple measurement occasions and a parameter indicating a metric for sharing the set of multiple measurement occasions between performing measurements and communication of data. The communications manager 820 is capable of, configured to, or operable to support a means for performing measurements during a first subset of the set of multiple measurement occasions. The communications manager 820 is capable of, configured to, or operable to support a means for communicating one or more data messages during one or more time periods that overlap at least partially with a second subset of the set of multiple measurement occasions, where one or more measurements are suppressed during the second subset of the set of multiple measurement occasions, and where a first quantity of measurement occasions of the first subset of the set of multiple measurement occasions and a second quantity of measurement occasions of the second subset of the set of multiple measurement occasions are determined based on the parameter.

By including or configuring the communications manager 820 in accordance with examples as described herein, the device 805 may support techniques for reduced latency and improved user experience related to reduced power consumption and the improved utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of measurement gap sharing with delay critical traffic as described herein, or the at least one processor 840 and the at least one memory 830 may be otherwise configured to, individually or collectively, perform or support such operations.

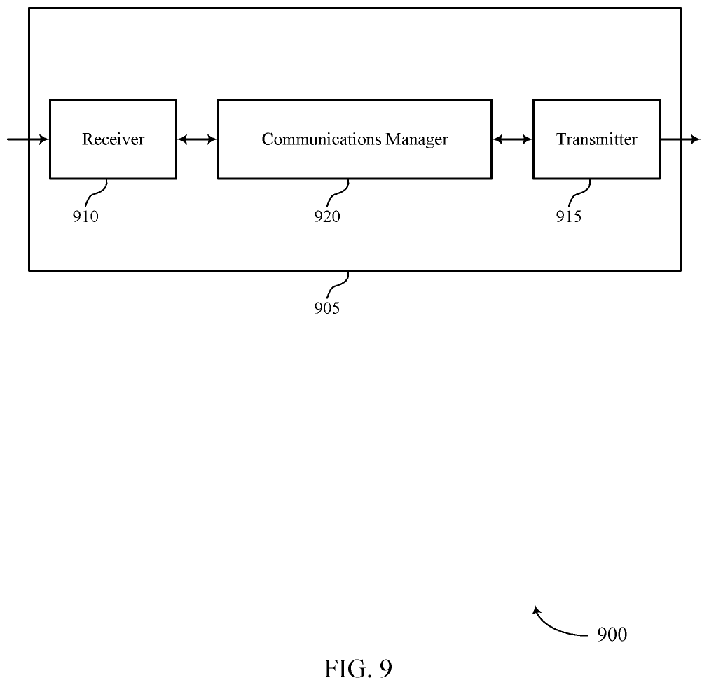

FIG. 9 shows a block diagram 900 of a device 905 that supports measurement gap sharing with delay critical traffic in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of measurement gap sharing with delay critical traffic as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, a GPU, a NPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software) executed by at least one processor. If implemented in code executed by at least one processor, the functions of the communications manager 920, the receiver 910, the transmitter 915, or various combinations or components thereof may be performed by a general-purpose processor, a DSP, a CPU, a GPU, a NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for transmitting, to a UE, an indication of a configuration for a set of multiple measurement occasions, the configuration including a periodicity of the set of multiple measurement occasions and a parameter indicating a metric for sharing the set of multiple measurement occasions between performing measurements and communication of data. The communications manager 920 is capable of, configured to, or operable to support a means for communicating one or more data messages with the UE during one or more time periods that overlap at least partially with a subset of the set of multiple measurement occasions.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption and the improved utilization of communication resources.

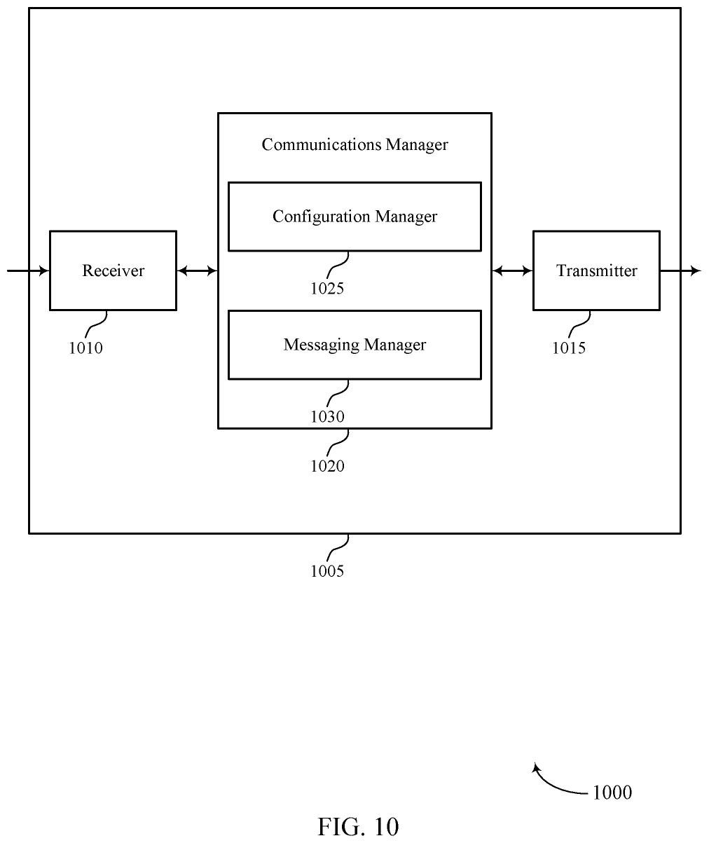

FIG. 10 shows a block diagram 1000 of a device 1005 that supports measurement gap sharing with delay critical traffic in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of measurement gap sharing with delay critical traffic as described herein. For example, the communications manager 1020 may include a configuration manager 1025 a messaging manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The configuration manager 1025 is capable of, configured to, or operable to support a means for transmitting, to a UE, an indication of a configuration for a set of multiple measurement occasions, the configuration including a periodicity of the set of multiple measurement occasions and a parameter indicating a metric for sharing the set of multiple measurement occasions between performing measurements and communication of data. The messaging manager 1030 is capable of, configured to, or operable to support a means for communicating one or more data messages with the UE during one or more time periods that overlap at least partially with a subset of the set of multiple measurement occasions.

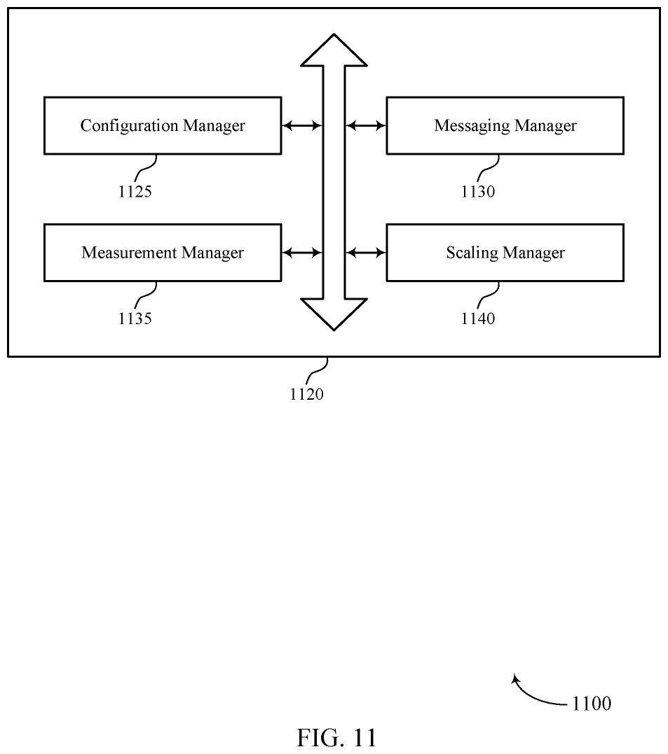

FIG. 11 shows a block diagram 1100 of a communications manager 1120 that supports measurement gap sharing with delay critical traffic in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of measurement gap sharing with delay critical traffic as described herein. For example, the communications manager 1120 may include a configuration manager 1125, a messaging manager 1130, a measurement manager 1135, a scaling manager 1140, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The configuration manager 1125 is capable of, configured to, or operable to support a means for transmitting, to a UE, an indication of a configuration for a set of multiple measurement occasions, the configuration including a periodicity of the set of multiple measurement occasions and a parameter indicating a metric for sharing the set of multiple measurement occasions between performing measurements and communication of data. The messaging manager 1130 is capable of, configured to, or operable to support a means for communicating one or more data messages with the UE during one or more time periods that overlap at least partially with a subset of the set of multiple measurement occasions.

In some examples, the configuration is based on a data type, one or more criteria associated with the UE satisfying a threshold, or any combination thereof.

In some examples, the data type is extended reality (XR) traffic, ultra-reliable and low latency communications (URLLC) traffic, or a combination thereof.

In some examples, the one or more criteria include criteria of one or more signal measurements performed by the UE on a serving cell associated with a network entity, a radio resource management relaxation condition, a quantity of data buffered in a logical channel, or any combination thereof.

In some examples, the one or more signal measurements performed by the UE on the serving cell associated with the network entity include a reference signal received power, a reference signal received quality, or both.

In some examples, the metric is a percentage value of the set of multiple measurement occasions, a fraction of the set of multiple measurement occasions, or any combination thereof.

In some examples, the measurement manager 1135 is capable of, configured to, or operable to support a means for performing intra-frequency measurements, inter-frequency measurements, or any combination thereof.

In some examples, the parameter further includes a second metric for sharing a second subset of the set of multiple measurement occasions between intra-frequency measurements and inter-frequency measurements.

In some examples, the scaling manager 1140 is capable of, configured to, or operable to support a means for determine a cell-detection period, a synchronization signal block index identification period, a measurement period, or any combination thereof based on a scaling factor associated with the parameter.

In some examples, the indication is transmitted via downlink control information, a medium access control-control element, radio resource control signaling, a system information message, or any combination thereof.

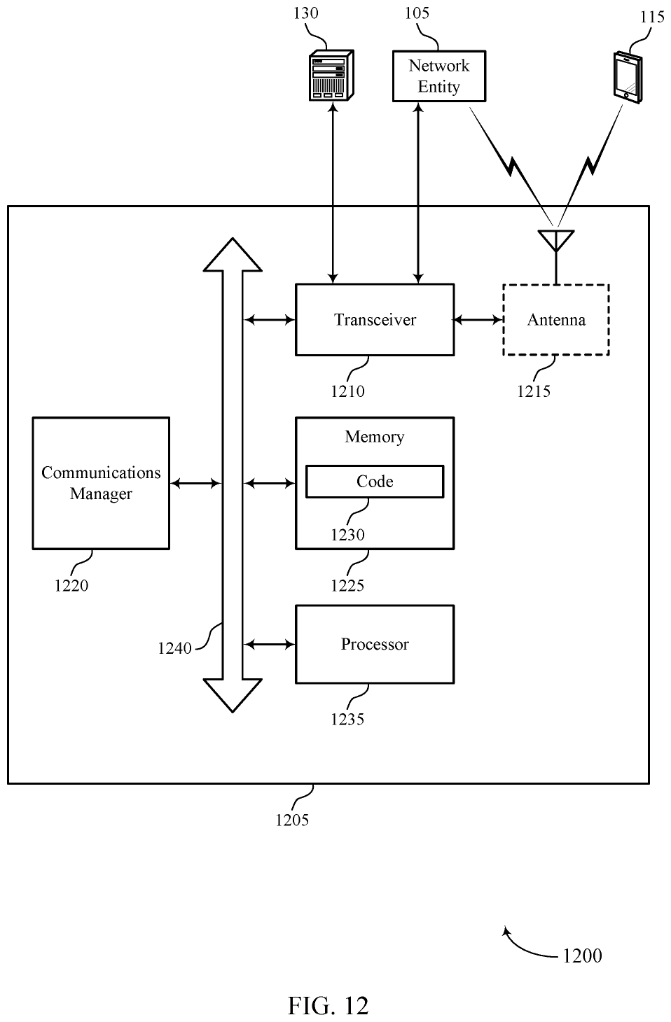

FIG. 12 shows a diagram of a system 1200 including a device 1205 that supports measurement gap sharing with delay critical traffic in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, a GPU, a NPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting measurement gap sharing with delay critical traffic). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 is capable of, configured to, or operable to support a means for transmitting, to a UE, an indication of a configuration for a set of multiple measurement occasions, the configuration including a periodicity of the set of multiple measurement occasions and a parameter indicating a metric for sharing the set of multiple measurement occasions between performing measurements and communication of data. The communications manager 1220 is capable of, configured to, or operable to support a means for communicating one or more data messages with the UE during one or more time periods that overlap at least partially with a subset of the set of multiple measurement occasions.

By including or configuring the communications manager 1220 in accordance with examples as described herein, the device 1205 may support techniques for reduced latency and improved user experience related to reduced power consumption and the improved utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of measurement gap sharing with delay critical traffic as described herein, or the at least one processor 1235 and the at least one memory 1225 may be otherwise configured to, individually or collectively, perform or support such operations.

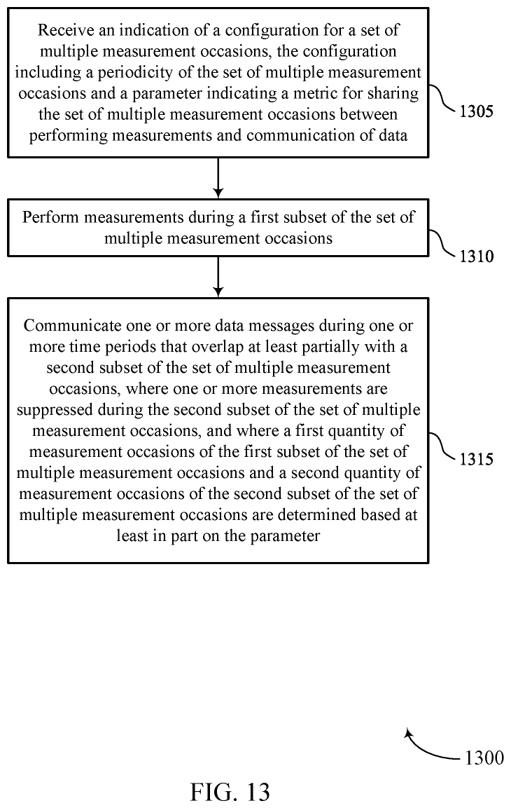

FIG. 13 shows a flowchart illustrating a method 1300 that supports measurement gap sharing with delay critical traffic in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a configuration for a set of multiple measurement occasions, the configuration including a periodicity of the set of multiple measurement occasions and a parameter indicating a metric for sharing the set of multiple measurement occasions between performing measurements and communication of data. The operations of block 1305 may be performed in accordance with examples as disclosed herein. In some examples, aspects of the operations of 1305 may be performed by a configuration component 725 as described with reference to FIG. 7.

At 1310, the method may include performing measurements during a first subset of the set of multiple measurement occasions. The operations of block 1310 may be performed in accordance with examples as disclosed herein. In some examples, aspects of the operations of 1310 may be performed by a measurement component 730 as described with reference to FIG. 7.

At 1315, the method may include communicating one or more data messages during one or more time periods that overlap at least partially with a second subset of the set of multiple measurement occasions, where one or more measurements are suppressed during the second subset of the set of multiple measurement occasions, and where a first quantity of measurement occasions of the first subset of the set of multiple measurement occasions and a second quantity of measurement occasions of the second subset of the set of multiple measurement occasions are determined based at least in part on the parameter. The operations of block 1315 may be performed in accordance with examples as disclosed herein. In some examples, aspects of the operations of 1315 may be performed by a messaging component 735 as described with reference to FIG. 7.

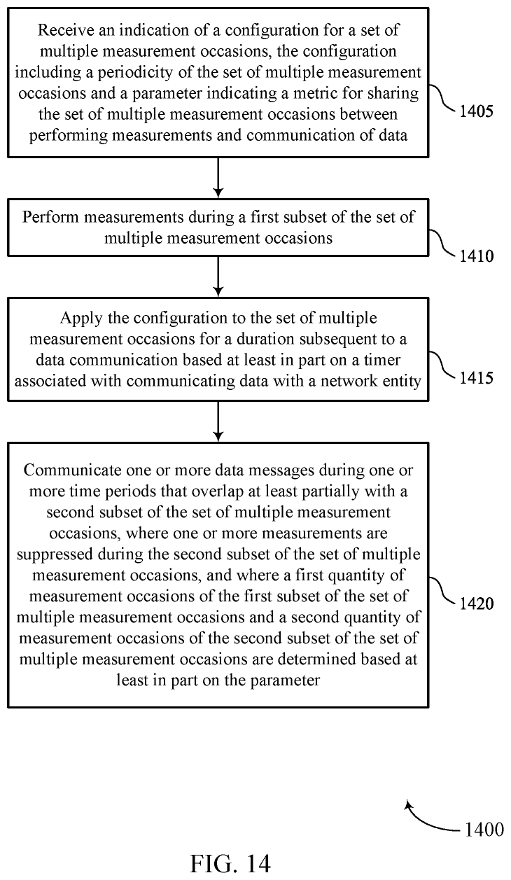

FIG. 14 shows a flowchart illustrating a method 1400 that supports measurement gap sharing with delay critical traffic in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving an indication of a configuration for a set of multiple measurement occasions, the configuration including a periodicity of the set of multiple measurement occasions and a parameter indicating a metric for sharing the set of multiple measurement occasions between performing measurements and communication of data. The operations of block 1405 may be performed in accordance with examples as disclosed herein. In some examples, aspects of the operations of 1405 may be performed by a configuration component 725 as described with reference to FIG. 7.

At 1410, the method may include performing measurements during a first subset of the set of multiple measurement occasions. The operations of block 1410 may be performed in accordance with examples as disclosed herein. In some examples, aspects of the operations of 1410 may be performed by a measurement component 730 as described with reference to FIG. 7.

At 1415, the method may include applying the configuration to the set of multiple measurement occasions for a duration subsequent to a data communication based at least in part on a timer associated with communicating data with a network entity. The operations of block 1415 may be performed in accordance with examples as disclosed herein. In some examples, aspects of the operations of 1415 may be performed by an application component 740 as described with reference to FIG. 7.

At 1420, the method may include communicating one or more data messages during one or more time periods that overlap at least partially with a second subset of the set of multiple measurement occasions, where one or more measurements are suppressed during the second subset of the set of multiple measurement occasions, and where a first quantity of measurement occasions of the first subset of the set of multiple measurement occasions and a second quantity of measurement occasions of the second subset of the set of multiple measurement occasions are determined based at least in part on the parameter. The operations of block 1420 may be performed in accordance with examples as disclosed herein. In some examples, aspects of the operations of 1420 may be performed by a messaging component 735 as described with reference to FIG. 7.

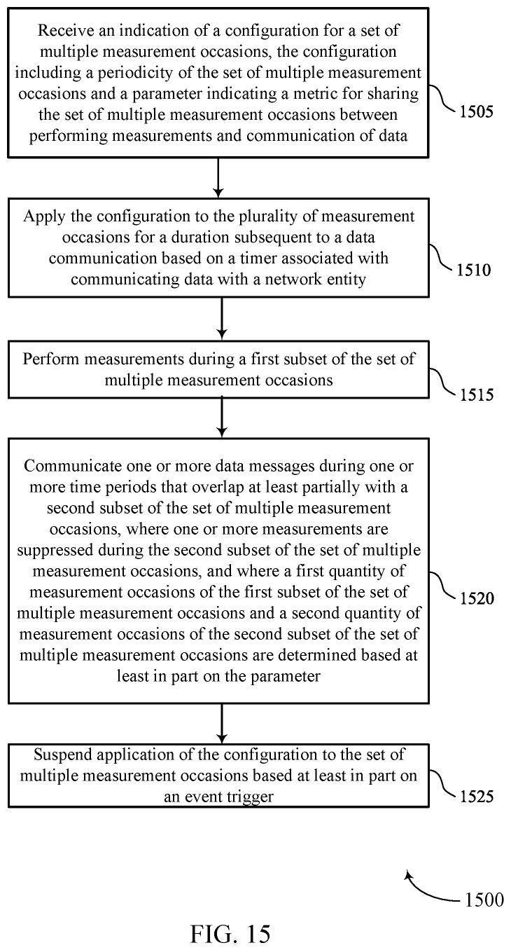

FIG. 15 shows a flowchart illustrating a method 1500 that supports measurement gap sharing with delay critical traffic in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving an indication of a configuration for a set of multiple measurement occasions, the configuration including a periodicity of the set of multiple measurement occasions and a parameter indicating a metric for sharing the set of multiple measurement occasions between performing measurements and communication of data. The operations of block 1505 may be performed in accordance with examples as disclosed herein. In some examples, aspects of the operations of 1505 may be performed by a configuration component 725 as described with reference to FIG. 7.

At 1510, the method may include applying the configuration to the plurality of measurement occasions for a duration subsequent to a data communication based at least in part on a timer associated with communicating data with a network entity. The operations of block 1510 may be performed in accordance with examples as disclosed herein. In some examples, aspects of the operations of 1510 may be performed by an application component 740 as described with reference to FIG. 7.

At 1515, the method may include performing measurements during a first subset of the set of multiple measurement occasions. The operations of block 1515 may be performed in accordance with examples as disclosed herein. In some examples, aspects of the operations of 1515 may be performed by a measurement component 730 as described with reference to FIG. 7.

At 1520, the method may include communicating one or more data messages during one or more time periods that overlap at least partially with a second subset of the set of multiple measurement occasions, where one or more measurements are suppressed during the second subset of the set of multiple measurement occasions, and where a first quantity of measurement occasions of the first subset of the set of multiple measurement occasions and a second quantity of measurement occasions of the second subset of the set of multiple measurement occasions are determined based at least in part on the parameter. The operations of block 1520 may be performed in accordance with examples as disclosed herein. In some examples, aspects of the operations of 1520 may be performed by a messaging component 735 as described with reference to FIG. 7.

At 1525, the method may include suspending application of the configuration to the set of multiple measurement occasions based at least in part on an event trigger. The operations of block 1525 may be performed in accordance with examples as disclosed herein. In some examples, aspects of the operations of 1525 may be performed by a triggering component 745 as described with reference to FIG. 7.

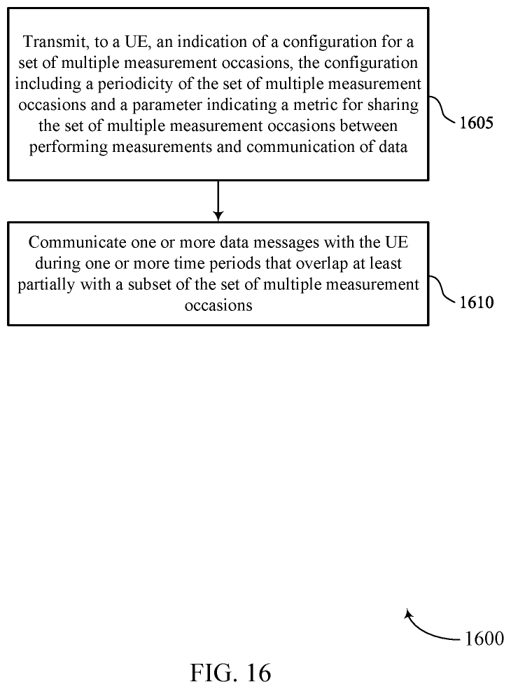

FIG. 16 shows a flowchart illustrating a method 1600 that supports measurement gap sharing with delay critical traffic in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, an indication of a configuration for a set of multiple measurement occasions, the configuration including a periodicity of the set of multiple measurement occasions and a parameter indicating a metric for sharing the set of multiple measurement occasions between performing measurements and communication of data. The operations of block 1605 may be performed in accordance with examples as disclosed herein. In some examples, aspects of the operations of 1605 may be performed by a configuration manager 1125 as described with reference to FIG. 11.

At 1610, the method may include communicating one or more data messages with the UE during one or more time periods that overlap at least partially with a subset of the set of multiple measurement occasions. The operations of block 1610 may be performed in accordance with examples as disclosed herein. In some examples, aspects of the operations of 1610 may be performed by a messaging manager 1130 as described with reference to FIG. 11.

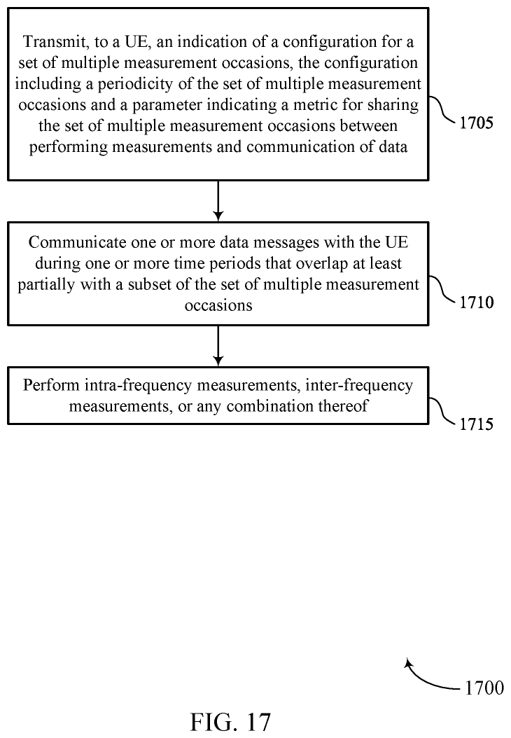

FIG. 17 shows a flowchart illustrating a method 1700 that supports measurement gap sharing with delay critical traffic in accordance with aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, an indication of a configuration for a set of multiple measurement occasions, the configuration including a periodicity of the set of multiple measurement occasions and a parameter indicating a metric for sharing the set of multiple measurement occasions between performing measurements and communication of data. The operations of block 1705 may be performed in accordance with examples as disclosed herein. In some examples, aspects of the operations of 1705 may be performed by a configuration manager 1125 as described with reference to FIG. 11.

At 1710, the method may include communicating one or more data messages with the UE during one or more time periods that overlap at least partially with a subset of the set of multiple measurement occasions. The operations of block 1710 may be performed in accordance with examples as disclosed herein. In some examples, aspects of the operations of 1710 may be performed by a messaging manager 1130 as described with reference to FIG. 11.

At 1715, the method may include performing intra-frequency measurements, inter-frequency measurements, or any combination thereof. The operations of block 1715 may be performed in accordance with examples as disclosed herein. In some examples, aspects of the operations of 1715 may be performed by a measurement manager 1135 as described with reference to FIG. 11.

The following provides an overview of aspects of the present disclosure:

Aspect 1: A method for wireless communication by a UE, comprising: receiving an indication of a configuration for a plurality of measurement occasions, the configuration comprising a periodicity of the plurality of measurement occasions and a parameter indicating a metric for sharing the plurality of measurement occasions between performing measurements and communication of data; performing measurements during a first subset of the plurality of measurement occasions; and communicating one or more data messages during one or more time periods that overlap at least partially with a second subset of the plurality of measurement occasions, wherein one or more measurements are suppressed during the second subset of the plurality of measurement occasions, and wherein a first quantity of measurement occasions of the first subset of the plurality of measurement occasions and a second quantity of measurement occasions of the second subset of the plurality of measurement occasions are determined based at least in part on the parameter.

Aspect 2: The method of aspect 1, wherein the metric is a percentage value of the plurality of measurement occasions, a fraction of the plurality of measurement occasions, or any combination thereof.

Aspect 3: The method of any of aspects 1 through 2, wherein the parameter further comprises a second metric for sharing the first subset of the plurality of measurement occasions between intra-frequency measurements and inter-frequency measurements.

Aspect 4: The method of any of aspects 1 through 3, further comprising: applying the configuration to the plurality of measurement occasions based at least in part on a data type, one or more criteria associated with the UE satisfying a threshold, or any combination thereof.

Aspect 5: The method of aspect 4, wherein the data type is XR traffic, URLLC traffic, or a combination thereof.

Aspect 6: The method of any of aspects 4 through 5, wherein the one or more criteria include criteria of one or more signal measurements performed by the UE on a serving cell associated with a network entity, a radio resource management relaxation condition, a quantity of data buffered in a logical channel, or any combination thereof.

Aspect 7: The method of aspect 6, wherein the one or more signal measurements performed by the UE on the serving cell associated with the network entity include a RSRP, a RSRQ, or both.

Aspect 8: The method of any of aspects 1 through 7, further comprising: applying the configuration to the plurality of measurement occasions for a duration subsequent to a data communication based at least in part on a timer associated with communicating data with a network entity.

Aspect 9: The method of any of aspects 1 through 8, further comprising: suspending application of the configuration to the plurality of measurement occasions based at least in part on an event trigger.

Aspect 10: The method of aspect 9, wherein the event trigger includes a RLF, a beam failure recovery, a candidate beam detection, a RSRP satisfying a first threshold, a RSRQ satisfying a second threshold, or any combination thereof.

Aspect 11: The method of any of aspects 1 through 10, further comprising: determining a cell-detection period, a synchronization signal block index identification period, a measurement period, or any combination thereof based at least in part on a scaling factor associated with the parameter.

Aspect 12: The method of any of aspects 1 through 11, further comprising: transmitting an indication that the UE is applying the parameter based at least in part on one or more criteria associated with the UE satisfying a threshold.

Aspect 13: The method of any of aspects 1 through 12, wherein the indication is received via downlink control information, a medium access control-control element, radio resource control signaling, a system information message, or any combination thereof.

Aspect 14: The method of any of aspects 1 through 13, further comprising performing intra-frequency measurements, inter-frequency measurements, or any combination thereof.

Aspect 15: A method for wireless communication by a network entity, comprising: transmitting, to a UE, an indication of a configuration for a plurality of measurement occasions, the configuration comprising a periodicity of the plurality of measurement occasions and a parameter indicating a metric for sharing the plurality of measurement occasions between performing measurements and communication of data; and communicating one or more data messages with the UE during one or more time periods that overlap at least partially with a subset of the plurality of measurement occasions.

Aspect 16: The method of aspect 15, wherein the configuration is based at least in part on a data type, one or more criteria associated with the UE satisfying a threshold, or any combination thereof.

Aspect 17: The method of aspect 16, wherein the data type is extended reality (XR) traffic, ultra-reliable and low latency communications (URLLC) traffic, or a combination thereof.

Aspect 18: The method of any of aspects 16 through 17, wherein the one or more criteria include criteria of one or more signal measurements performed by the UE on a serving cell associated with a network entity, a radio resource management relaxation condition, a quantity of data buffered in a logical channel, or any combination thereof.

Aspect 19: The method of aspect 18, wherein the one or more signal measurements performed by the UE on the serving cell associated with the network entity include a reference signal received power, a reference signal received quality, or both.

Aspect 20: The method of any of aspects 15 through 19, wherein the metric is a percentage value of the plurality of measurement occasions, a fraction of the plurality of measurement occasions, or any combination thereof.

Aspect 21: The method of any of aspects 15 through 20, further comprising performing intra-frequency measurements, inter-frequency measurements, or any combination thereof.

Aspect 22: The method of aspect 21, wherein the parameter further comprises a second metric for sharing a second subset of the plurality of measurement occasions between intra-frequency measurements and inter-frequency measurements.

Aspect 23: The method of any of aspects 15 through 22, further comprising: determine a cell-detection period, a synchronization signal block index identification period, a measurement period, or any combination thereof based at least in part on a scaling factor associated with the parameter.

Aspect 24: The method of any of aspects 15 through 23, further comprising: receiving an indication that the UE is applying the parameter based at least in part on one or more criteria associated with the UE satisfying a threshold.

Aspect 25: The method of any of aspects 15 through 24, wherein the indication is transmitted via downlink control information, a medium access control-control element, radio resource control signaling, a system information message, or any combination thereof.

Aspect 26: A UE for wireless communication, comprising one or more memories storing processor-executable code, and one or more processors coupled with the one or more memories and individually or collectively operable to execute the code (e.g., directly, indirectly, after pre-processing, without pre-processing) to cause the UE to perform a method of any of aspects 1 through 14.

Aspect 27: A UE for wireless communication, comprising at least one means for performing a method of any of aspects 1 through 14.

Aspect 28: A non-transitory computer-readable medium storing code for wireless communication, the code comprising instructions executable by a processor (e.g., directly, indirectly, after pre-processing, without pre-processing) to perform a method of any of aspects 1 through 14.

Aspect 29: A network entity for wireless communication, comprising one or more memories storing processor-executable code, and one or more processors coupled with the one or more memories and individually or collectively operable to execute the code (e.g., directly, indirectly, after pre-processing, without pre-processing) to cause the network entity to perform a method of any of aspects 15 through 25.

Aspect 30: A network entity for wireless communication, comprising at least one means for performing a method of any of aspects 15 through 25.

Aspect 31: A non-transitory computer-readable medium storing code for wireless communication, the code comprising instructions executable by a processor (e.g., directly, indirectly, after pre-processing, without pre-processing) to perform a method of any of aspects 15 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an indication of a configuration for a plurality of measurement occasions, the configuration comprising a periodicity of the plurality of measurement occasions and a parameter indicating a metric for sharing the plurality of measurement occasions between performing measurements and communication of data;
perform measurements during a first subset of the plurality of measurement occasions; and
communicate one or more data messages during one or more time periods that overlap at least partially with a second subset of the plurality of measurement occasions, wherein one or more measurements are suppressed during the second subset of the plurality of measurement occasions, and wherein a first quantity of measurement occasions of the first subset of the plurality of measurement occasions and a second quantity of measurement occasions of the second subset of the plurality of measurement occasions are determined based at least in part on the parameter.

2. The UE of claim 1, wherein the metric is a percentage value of the plurality of measurement occasions, a fraction of the plurality of measurement occasions, or any combination thereof.

3. The UE of claim 1, wherein the parameter further comprises a second metric for sharing the first subset of the plurality of measurement occasions between intra-frequency measurements and inter-frequency measurements.

4. The UE of claim 1, wherein the one or more processors are individually or collectively further operable to execute the code to cause the UE to:
apply the configuration to the plurality of measurement occasions based at least in part on a data type, one or more criteria associated with the UE satisfying a threshold, or any combination thereof.

5. The UE of claim 4, wherein the data type is extended reality (XR) traffic, ultra-reliable and low latency communications (URLLC) traffic, or a combination thereof.

6. The UE of claim 4, wherein the one or more criteria include criteria of one or more signal measurements performed by the UE on a serving cell associated with a network entity, a radio resource management relaxation condition, a quantity of data buffered in a logical channel, or any combination thereof.

7. The UE of claim 6, wherein the one or more signal measurements performed by the UE on the serving cell associated with the network entity include a reference signal received power, a reference signal received quality, or both.

8. The UE of claim 1, wherein the one or more processors are individually or collectively further operable to execute the code to cause the UE to:
apply the configuration to the plurality of measurement occasions for a duration subsequent to a data communication based at least in part on a timer associated with communicating data with a network entity.

9. The UE of claim 1, wherein the one or more processors are individually or collectively further operable to execute the code to cause the UE to:
suspend application of the configuration to the plurality of measurement occasions based at least in part on an event trigger.

10. The UE of claim 9, wherein the event trigger includes a radio link failure, a beam failure recovery, a candidate beam detection, a reference signal received power satisfying a first threshold, a reference signal received quality satisfying a second threshold, or any combination thereof.

11. The UE of claim 1, wherein the one or more processors are individually or collectively further operable to execute the code to cause the UE to:
determine a cell-detection period, a synchronization signal block index identification period, a measurement period, or any combination thereof based at least in part on a scaling factor associated with the parameter.

12. The UE of claim 1, wherein the one or more processors are individually or collectively further operable to execute the code to cause the UE to:
transmit an indication that the UE is applying the parameter based at least in part on one or more criteria associated with the UE satisfying a threshold.

13. The UE of claim 1, wherein the indication is received via downlink control information, a medium access control-control element, radio resource control signaling, a system information message, or any combination thereof.

14. The UE of claim 1, wherein the one or more processors are individually or collectively further operable to execute the code to cause the UE to:
perform intra-frequency measurements, inter-frequency measurements, or any combination thereof.

15. A network entity, comprising:
one or more memories storing processor-executable code; and
one or more processors coupled with the one or more memories and individually or collectively operable to execute the code to cause the network entity to:
transmit, to a user equipment (UE), an indication of a configuration for a plurality of measurement occasions, the configuration comprising a periodicity of the plurality of measurement occasions and a parameter indicating a metric for sharing the plurality of measurement occasions between performing measurements and communication of data; and
communicate one or more data messages with the UE during one or more time periods that overlap at least partially with a subset of the plurality of measurement occasions.

16. The network entity of claim 15, wherein the configuration is based at least in part on a data type, one or more criteria associated with the UE satisfying a threshold, or any combination thereof.

17. The network entity of claim 16, wherein the data type is extended reality (XR) traffic, ultra-reliable and low latency communications (URLLC) traffic, or a combination thereof.

18. The network entity of claim 16, wherein the one or more criteria include criteria of one or more signal measurements performed by the UE on a serving cell associated with a network entity, a radio resource management relaxation condition, a quantity of data buffered in a logical channel, or any combination thereof.

19. The network entity of claim 18, wherein the one or more signal measurements performed by the UE on the serving cell associated with the network entity include a reference signal received power, a reference signal received quality, or both.

20. The network entity of claim 15, wherein the metric is a percentage value of the plurality of measurement occasions, a fraction of the plurality of measurement occasions, or any combination thereof.

21. The network entity of claim 15, wherein the one or more processors are individually or collectively further operable to execute the code to cause the network entity to:
perform intra-frequency measurements, inter-frequency measurements, or any combination thereof.

22. The network entity of claim 21, wherein the parameter further comprises a second metric for sharing a second subset of the plurality of measurement occasions between intra-frequency measurements and inter-frequency measurements.

23. The network entity of claim 15, wherein the one or more processors are individually or collectively further operable to execute the code to cause the network entity to:
determine a cell-detection period, a synchronization signal block index identification period, a measurement period, or any combination thereof based at least in part on a scaling factor associated with the parameter.

24. The network entity of claim 15, wherein the one or more processors are individually or collectively further operable to execute the code to cause the network entity to:
receive an indication that the UE is applying the parameter based at least in part on one or more criteria associated with the UE satisfying a threshold.

25. The network entity of claim 15, wherein the indication is transmitted via downlink control information, a medium access control-control element, radio resource control signaling, a system information message, or any combination thereof.

26. A method for wireless communication by a user equipment (UE), comprising:
receiving an indication of a configuration for a plurality of measurement occasions, the configuration comprising a periodicity of the plurality of measurement occasions and a parameter indicating a metric for sharing the plurality of measurement occasions between performing measurements and communication of data;
performing measurements during a first subset of the plurality of measurement occasions; and
communicating one or more data messages during one or more time periods that overlap at least partially with a second subset of the plurality of measurement occasions, wherein one or more measurements are suppressed during the second subset of the plurality of measurement occasions, and wherein a first quantity of measurement occasions of the first subset of the plurality of measurement occasions and a second quantity of measurement occasions of the second subset of the plurality of measurement occasions are determined based at least in part on the parameter.

27. The method of claim 26, further comprising:
applying the configuration to the plurality of measurement occasions for a duration subsequent to a data communication based at least in part on a timer associated with communicating data with a network entity.

28. The method of claim 26, further comprising:
suspending application of the configuration to the plurality of measurement occasions based at least in part on an event trigger.

29. A method for wireless communication by a network entity, comprising:
transmitting, to a user equipment (UE), an indication of a configuration for a plurality of measurement occasions, the configuration comprising a periodicity of the plurality of measurement occasions and a parameter indicating a metric for sharing the plurality of measurement occasions between performing measurements and communication of data; and
communicating one or more data messages with the UE during one or more time periods that overlap at least partially with a subset of the plurality of measurement occasions.

30. The method of claim 29, wherein the configuration is based at least in part on a data type, one or more criteria associated with the UE satisfying a threshold, or any combination thereof.
